(19) United States
(12) Patent Application Publication
(10) Pub. No.: US 2022/0100003 A1
(43) Pub. Date: Mar. 31, 2022

(54) SUCTION PUMP ORTHOKERATOLOGY LENS

(71) Applicant: OPTACT INTERNATIONAL CO., LTD., TAIPEI (TW)

(72) Inventor: ZERN-YU CHOU, Taipei (TW)

(21) Appl. No.: 17/488,527

(22) Filed: Sep. 29, 2021

(30) Foreign Application Priority Data
Sep. 29, 2020 (TW) 109212846

(51) Int. Cl. G02C 7/04

(52) U.S. Cl. CPC G02C 7/047; G02C 2202/06

(57) ABSTRACT

A suction pump orthokeratology lens includes an outer surface and an inner surface. The inner surface includes a base curve, a reverse curve, and a stable curve. When the user wears the orthokeratology lens, the base curve generates a pressing force to the eye and causes the cornea to deform in the direction of the reverse curve. Since the stable curve is provided with at least one contact point which forms a tiny suction force, the orthokeratology lens can also slide for shaping without injuring the cornea when the stable curve is in contact with the cornea. The invention draws the cornea to the position of the base curve and the reverse curve through tear exchange and suction pump and shapes the cornea according to the shape of the base curve. Therefore, the user can effectively shape the cornea and correct vision after wearing the suction pump orthokeratology lens.

### REFERENCE TO RELATED APPLICATIONS

The present application is based on, and claims priority from, Taiwan application number 109212846 filed Sep. 29, 2020, the disclosure of which is hereby incorporated by reference herein in its entirety.

### BACKGROUND OF THE INVENTION

### 1. Field of the Invention

The present disclosure relates to the field of corneal shaping technology. Specifically, the present invention relates to a suction pump orthokeratology lens that shapes the cornea through suction pump technology.

### 2. Description of the Related Art

Orthokeratology (OK) is a technique that gradually changes the shape of the cornea by systematically wearing a rigid orthokeratology lens to temporarily improve or remove the refractive error.

In general, the special design of the orthokeratology lens can gently change the shape of the corneal surface in a gradual manner, turning it into a spherical curve, to effectively reduce myopia and corneal astigmatism. The patient can retain clear vision after correction, but the cornea will return to its original shape if not worn for a long time.

Therefore, conventional technology requires the constant replacement of hard contact lenses during the correction period. That is, the conventional orthokeratology lens must be worn for a long time to achieve the effect of correcting vision.

As mentioned previously, shaping the cornea effectively and shortening the time for shaping the cornea has become an urgent issue in this technical field that needs to be improved.

### SUMMARY OF THE INVENTION

To solve the lack of orthokeratology mentioned before, one of the purposes in the present invention is to effectively shape the cornea and shorten the time of corneal shaping, thereby achieving the goal of significant vision correction.

In order to achieve the above purpose, the present invention provides a suction pump orthokeratology lens, comprising an outer surface and an inner surface; wherein the inner surface comprising a stable curve positioned on the outer periphery of the inner surface with an asymmetrical shape; a base curve positioned at the center-periphery of the inner surface, and the base curve generates a pressing force to the eyes of a user; and a reverse curve positioned between the base curve and the stable curve of the inner surface with a symmetrical or asymmetrical shape, and a suction pumping room is formed between the base curve, the reverse curve, and the eye.

In particular, when the base curve generates the pressing force to the eye, the cornea in the suction pumping room will deform in the direction of the reverse curve and the base curve's position according to the base curve's shape.

Since the stable curve is an asymmetric shape and matched with the asymmetric shape of the cornea, it can generate a tiny suction force, so that although the orthokeratology lens would contact the cornea, it could still slide on the eye without injuring the cornea.

In particular, the stable curve has at least one contact point, and the contact point is in contact with the cornea so that a gap is formed between the stable curve and the eye to generate a tiny suction force, which wouldn't affect the stability of the lens on the eye. It can also help the suction pump orthokeratology lens slidably worn on the eyes.

In particular, the left and right or up and down shapes of the reverse curve are symmetrical or asymmetrical with each other.

### BRIEF DESCRIPTION OF THE DRAWINGS

For easier to understanding the above disclosure and other objects, features, advantages, and embodiments of the present invention, the description of the drawings is as follows:

FIG. 1 demonstrates a schematic diagram of the structure of the present invention;

FIG. 2 demonstrates a schematic diagram of the usage status of the present invention;

FIG. 3 demonstrates a schematic diagram of the structure after the deformation of the base curve in the present invention;

FIG. 4 demonstrates a schematic diagram of the eye after shaping in the present invention;

FIG. 5 demonstrates a schematic diagram of the usage status of the asymmetric reverse curve in the present invention;

FIG. 6A demonstrates a loose state schematic diagram after wearing the suction pump orthokeratology lens of the present invention;

FIG. 6B demonstrates an over-tight state schematic diagram after wearing the suction pump orthokeratology lens of the present invention;

FIG. 6C demonstrates a schematic diagram after correctly wearing the suction pump orthokeratology lens of the present invention.

100: Suction pump orthokeratology lens
10: Outer surface
20: Inner surface
30: Base curve
40: Reverse curve
50: Stable curve
51: Contact point
60: Eye
61: Cornea
70: Artificial tears
SR: Suction pumping room

According to the common operating method, the various features and elements in the figure are not drawn to actual scale. The drawing method aims to present the specific features and elements related to the present invention in the best way. In addition, the same or similar element symbols are used to indicate similar elements and components in different drawings.

### DETAILED DESCRIPTION OF THE PREFERRED EMBODIMENTS

The descriptions presented in embodiments of the specification are only technical philosophy and characteristics of the present application that can be understood and practiced by a person skilled in the art; the embodiments which should not be taken as examples to limit claims, thereinafter may be modified or changed by the person based on the disclosed embodiments in the present disclosure without departing from the spirit of claims.

The following is a further description of this creation in conjunction with the diagrams:

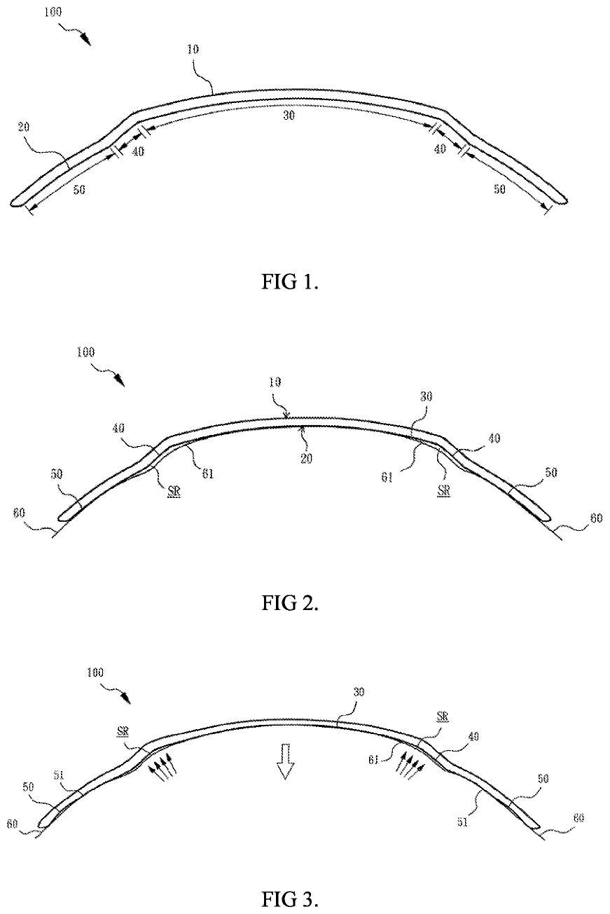

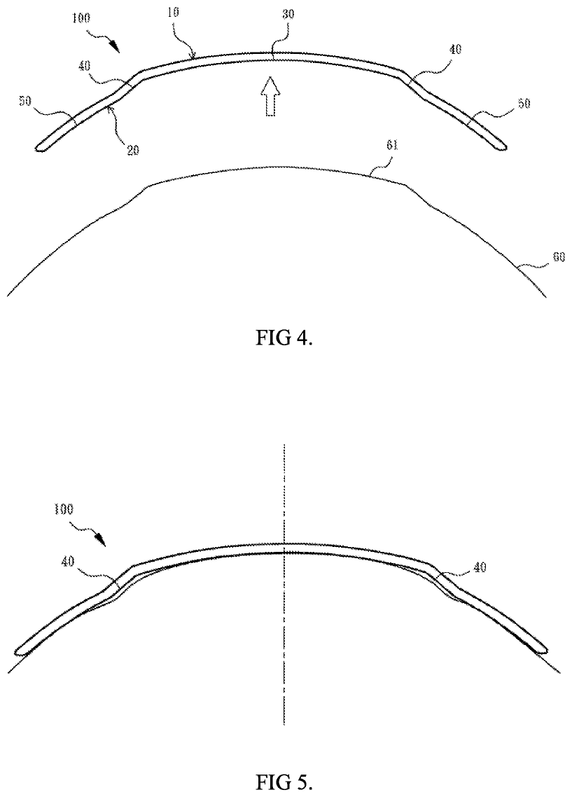

FIGS. 1 to 4 are the schematic diagram of the structure, the schematic diagram of the usage status, the schematic diagram of the structure after the deformation of the base curve and the schematic diagram of the eye after shaping in the present invention. According to FIG. 1, the present invention provides a suction pump orthokeratology lens 100, comprising an outer surface 10 and an inner surface 20; wherein the inner surface 20 comprising a base curve 30, a reverse curve 40, and a stable curve 50.

The base curve 30 is positioned at the center-periphery of the inner surface 20. When the user wears the orthokeratology lens 100, the base curve 30 will generate a pressing force to the eye and deform the eye which is on the relative position of the base curve.

The reverse curve 40 is positioned between the base curve 30 and the stable curve 50 of the inner surface 20 with a symmetrical or asymmetrical shape, and a suction pumping room SR is formed between the base curve 30, the reverse curve 40, and the eye 60. When the eye 60 deformed under the pressing force, the cornea 61 in the suction pumping room SR will deform in the direction of the position of the base curve 30 and reverse curve 40. And the deformation of the cornea 61 is according to the shape of the base curve 30. At the same time, the eye epithelial cell fluid located near the pressing force will flow away from the pressing force.

The stable curve 50 is positioned on the outer periphery of the inner surface 20 with an asymmetrical shape. When the base curve 30 generates the pressing force to the cornea 61 and deforms the cornea 61, the cornea 61 corresponding to the base curve 30 in the suction pump room SR will be compressed and deformed inward. And the cornea 61 corresponding to reverse curve 40 and/or the base curve 30 in the suction pump room SR will deform in the direction of the reverse curve 40 and/or the base curve 30. The deformation of the cornea 61 is according to the shape of the base curve 30.

The suction pump orthokeratology lens 100 is positioned on the eye 60 through the stable curve 50. The suction pump orthokeratology lens 100 can be accurately positioned on the eye 60 through the stable curve 50, and the reverse curve 40 can be located on the cornea 61. The stable curve 50 is provided on the outer periphery of the inner surface 20, so that the reverse curve 40 is provided between the base curve 30 and the stable curve 50. When the stable curve 50 contacts the eye 60, the stable curve 50 has at least one contact point 51, and the contact point 51 is in contact with the cornea 61 so that a gap is formed between the stable curve 50 and the eye 60 to generate a tiny suction force which does not affect stability. The tiny suction force causes the stable curve 50 to slidably contact the eye 60, and positions the suction pump orthokeratology lens 100 on the eye 60.

In addition, the stable curve 50 can help the epithelial cell fluid of the eye 60 to flow in the direction of the reverse curve 40 and/or the base curve 30 to perform the shaping treatment of the cornea 61.

In some embodiment, the stable curve 50 has at least two contact points 51, and each of the contact points 51 is in contact with the cornea so that a gap is formed between the stable curve 50 and the eye 60 to generate a tiny suction force which does not affect stability. It guides the epithelial cell fluid of the eye flow toward the middle position, so that the cornea 61 can be shaped more effectively.

Based on the above structure, when the user wears the suction pump orthokeratology lens 100, the base curve 30 will press the eye 60 to deform the eye 60 inwardly. Meanwhile, the cornea 61 will deform toward the position of the reverse curve 40 and/or the base curve 30, and shape the cornea 61 of the eye 60 to achieve the effect of correcting vision.

FIG. 5 demonstrates a schematic diagram of the usage status of the asymmetric reverse curve 40 in the present invention. The left and right or up and down shapes of the reverse curve 40 can be symmetrical or asymmetrical with each other. In the present embodiment, the reverse curve 40 is an asymmetrical shape. In this way, when deforming toward the position of the reverse curve 40 and/or the base curve 30, different shaping states can be adjusted according to the left-right asymmetry shape and different conditions of the users themselves.

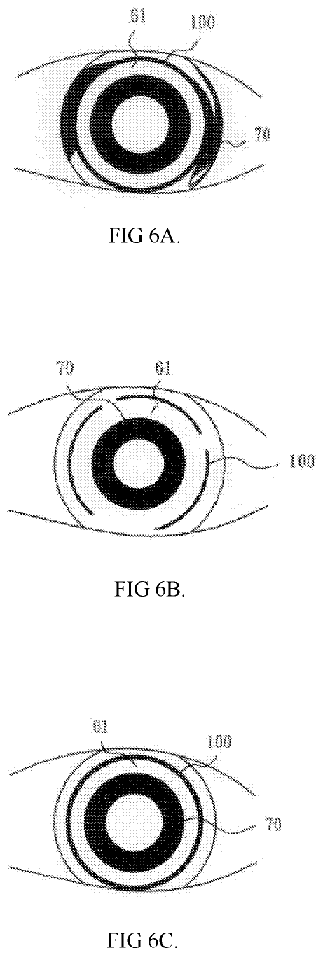

FIGS. 6A to 6C are schematic diagrams to determine the tightness after wearing the suction pump orthokeratology lens 100 of the present invention. As shown in the figure, the tightness of the suction pump orthokeratology lens 100 is evaluated based on the line of the stable curve 50. When assembling, lubricating fluid plus a fluorescent agent and blue light are used for checking the tear exchange and thickness. For example, using artificial tears 70 (colored tears), or other liquids with similar functions.

As shown in FIG. 6A, when the suction pump orthokeratology lens 100 is too loose, the artificial tears 70 will flow out from the loose joint between the cornea 61 and the suction pump orthokeratology lens 100. Therefore, it will not have a suction effect when it's too loose. As shown in FIG. 6B, if it is in an over-tight state, while the suction pump orthokeratology lens 100 and the cornea 61 are too tight, the stable curve 50 lines of the outer peripheral of the suction pump orthokeratology lens 100 disappeared. It is difficult to remove the suction pump orthokeratology lens 100 when it is too tight. FIG. 6C shows that in the correct wearing state, two full circles should be formed between the suction pump orthokeratology lens 100 and the cornea 61. Therefore, only the correct wearing of the suction pump orthokeratology lens 100 can effectively achieve the expected effects such as vision correction in the present invention.

The above detailed descriptions are specific descriptions of possible embodiments of the present invention, but these embodiments are not intended to limit the scope of the present invention. Any equivalent implementation or change without departing from the technical spirit of the present invention should be covered in the scope of this patent.

What is claimed is:

1. A suction pump orthokeratology lens, comprising an outer surface and an inner surface;
wherein the inner surface comprising:
a stable curve positioned on the outer periphery of the inner surface with an asymmetrical shape;
a base curve positioned at the center-periphery of the inner surface, and the base curve generates a pressing force to the eyes of a user; and
a reverse curve positioned between the base curve and the stable curve of the inner surface with a symmetrical or asymmetrical shape, and a suction pumping room is formed between the base curve, the reverse curve, and the eye; wherein the suction pump orthokeratology lens is positioned on the eye through the stable curve; when the base curve generates the pressing force to the eye and deforms the eye, a cornea in the suction pumping room will deform in the direction of the reverse curve, or the end position of the reverse curve and the base curve, to shape the cornea at the reverse curve, or the end position of the reverse curve and the base curve.

2. The suction pump orthokeratology lens as claimed in claim 1, wherein the stable curve provides a small suction force that does not affect stability, so that the stable curve contacts the eye.

3. The suction pump orthokeratology lens as claimed in claim 2, wherein the stable curve has at least one contact point, and the contact point is in contact with the cornea so that a gap is formed between the stable curve and the eye to generate the suction force, to position the suction pump orthokeratology lens on the eye.

4. The suction pump orthokeratology lens as claimed in claim 2, wherein the stable curve has at least two contact points, and each of the contact points is in contact with the cornea so that a gap is formed between the stable curve and the eye to generate the suction force, to guide the epithelial cell fluid of the eye flow toward the middle position.

5. The suction pump orthokeratology lens as claimed in claim 1, wherein the left and right or top and bottom shapes of the reverse curve are symmetrical or asymmetrical.

6. A suction pump orthokeratology lens, comprising an outer surface and an inner surface;
wherein the inner surface comprising:
a base curve positioned at the center-periphery of the inner surface, and the base curve generates a pressing force to the eyes of a user; and a stable curve positioned on the outer periphery of the inner surface with an asymmetrical shape and the stable curve is fixed on the eye so that the suction pump orthokeratology lens is positioned on the eye.

7. The suction pump orthokeratology lens as claimed in claim 6, wherein the stable curve provides a small suction force that does not affect stability, so that the stable curve contacts the eye.

8. The suction pump orthokeratology lens as claimed in claim 7, wherein the stable curve has at least one contact point, and the contact point is in contact with the cornea so that a gap is formed between the stable curve and the eye to generate the suction force, to position the suction pump orthokeratology lens on the eye.

9. The suction pump orthokeratology lens as claimed in claim 7, wherein the stable curve has at least two contact points, and each of the contact points is in contact with the cornea so that a gap is formed between the stable curve and the eye to generate the suction force, to guide the epithelial cell fluid of the eye flow toward the middle position.
